(19) United States
(12) Patent Application Publication
(10) Pub. No.: US 2015/0213075 A1
(43) Pub. Date: Jul. 30, 2015

(54) USE OF PRIMARY AND SECONDARY CONNECTION TABLES

(71) Applicants: James Collinge, Austin, TX (US); James M. Rolette, Round Rock, TX (US); Matthew Laswell, Austin, TX (US); Julian Palmer, Edinburgh (GB)

(72) Inventors: James Collinge, Austin, TX (US); James M. Rolette, Round Rock, TX (US); Matthew Laswell, Austin, TX (US); Julian Palmer, Edinburgh (GB)

(21) Appl. No.: 14/418,920

(22) PCT Filed: Sep. 10, 2012
(86) PCT No.: PCT/US2012/054523

§ 371 Date: Jan. 30, 2015

(51) Int. Cl. G06F 17/30; H04L 29/08

(52) U.S. Cl. CPC G06F 17/30339; H04L 67/1097

(57) ABSTRACT

A process may include selecting from among entries in a primary connection table, an entry to be removed from a primary connection table in order to create space for another entry in the primary connection table. The process may further store in a secondary connection table an entry for the connection corresponding to the selected entry.

### BACKGROUND

Systems and processes for network or cloud services may need to deal with millions of connections and sessions. Often existing solutions cannot meet the requirements on this scale because the state information is held locally in the memory of an appliance. In particular, most network products on the market today have connection or session ceilings that result from limits on the size of tables used to maintain the connections or sessions. Once these limitations are reached, a network product may no longer be able to accept new connections. “Denial of Service” attacks may attempt to exploit these limitations by exhausting the connection table of a network appliance such as a firewall. Such attacks may, for example, form millions of partial connections in the hope of filling the connection table of a network device and preventing legitimate traffic from being initiated. Because of the limitations of network appliances and the need to reduce vulnerability to “Denial of Service” attacks, network solutions often need to deploy more appliances, which increase system complexity and costs. The increased costs include not just the capital cost of more appliances but also increased management and maintenance costs.

### BRIEF DESCRIPTION OF THE DRAWINGS

FIG. 1A is a block diagram of a device that employs primary and secondary connection tables.

FIG. 1B is a block diagram of a system containing a network device that uses a secondary connection table that may be in different storage devices.

FIG. 2 illustrates logical relationships of primary and secondary connection tables in one implementation of a network device.

FIG. 3 illustrates logical relationships of a shared lookup structure with primary and secondary connection tables that employ hash tables.

FIG. 4 shows a format for a connection table entry.

FIG. 5 is a flow diagram of a process that moves information from a primary connection table to a secondary connection table to maintain space in the primary connection table.

FIG. 6 is a flow diagram of a process for processing a packet received by a network device employing primary and secondary connection tables.

FIG. 7 is a flow diagram of one specific implementation of a process that makes space in a primary connection table by offloading one or more entries in the primary connection table to a secondary connection table.

Use of the same reference symbols in different figures indicates similar or identical items.

### DETAILED DESCRIPTION

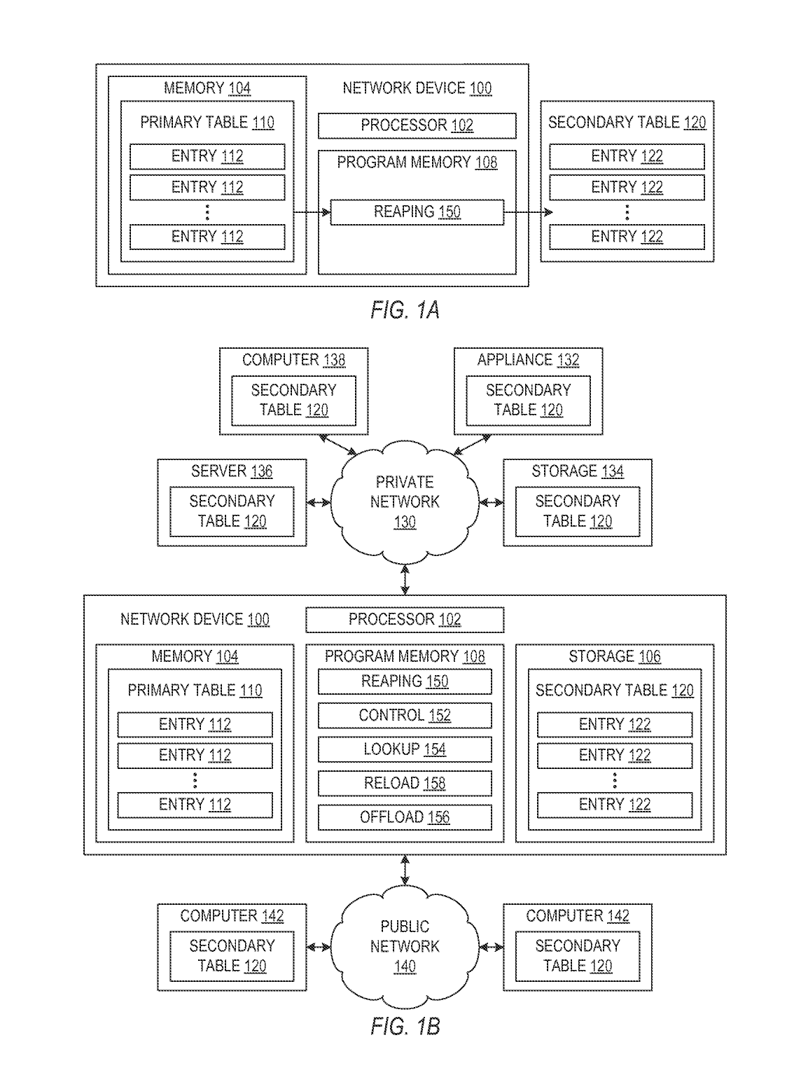

A network device 100 such as shown in FIG. 1A may have the ability to offload aging connections or session entries and the states of such connections or sessions from a local primary connection table 110 in a main memory 104 of network device 100 to a secondary connection table 120 that may be stored in any available storage in network device 100 or elsewhere. In particular, a reaping module 150 that is in a program memory 108 and executed by a processor 102 of network device 100 may offload of one or more entries 112 to secondary connection table 120 to provide space in primary connection table 110 for new entries 112, and effectively makes the size of the connection table scalable to any desired size. Normally, but not always, a connection entry may be in one of primary connection table 110 or secondary connection table 120, but not both at the same time. If an offloaded connection attempts to establish communications, network device 100 can query secondary connection table 120, retrieve an entry 122 with status information associated with the connection, and re-establish an appropriate entry 112 in primary connection table 110.

Device 100 may have the ability to classify connections or sessions, e.g., identity the device or application that is associated with or trying to establish a session/connection, identify the use of the connection, or determine the sensitivity of a connection or session to latency. Further, the particular entries 112 selected for offloads may be selected using entry information in an attempt to minimize negative effects on performance. For example, the offloaded entries 112 may be selected based on age, last use, and associated application, so that the connections that are least likely to be used or the connections that would be least affected are offloaded. In the configuration of FIG. 1A, reaping module 150 may implement such selection logic or any desired business logic and employ the classification of a connection in determining which connections or entries 112 to offload to the secondary connection table 122. In particular, retrieval of a connection or session information in an entry 122 of secondary table 120 may introduce latency, and the ability to detect the type of service that is connecting can be important in optimizing performance. Services such as print, email, and backup are good candidates for offloading connection entries 112 while other services such as streaming media or web browsing may not be. A table control module can detect the service type and either automatically control or allow an administrator to control which aging services reaping module 150 can push to secondary table 120.

FIG. 18 is a block diagram providing more detail of network device 100 in a system that employs primary and secondary connection tables 110 and 120. Network device 100 may, for example, be network equipment such as a firewall, an intrusion prevention system, a web server, a router, or any middlebox that needs to maintain a connection table or a similar structure such as a TCP/IP stack. Network device 100 can be implemented as an appliance, e.g., computer appliance or network appliance. An appliance is generally a separate and discrete hardware device that is designed to provide a specific resource and contains integrated software that may be difficult to significantly alter. Network device 100 could alternatively be implemented in a general purpose computer, e.g., as part of a general purpose operating system or a software application. Another alternative implementation of network device 100 could be as a software service in a virtualized environment, e.g., “the cloud.” The following concentrates on describing one implementation in which device 100 is a firewall appliance.

Network device 100 may use primary table 110 and secondary table 120 to control data passing in or out of nodes on a network 130. Network 130 in the example of FIG. 1B includes an appliance 132, a network-attached storage device 134, a server 136, and a computer 138. Appliance 132 may be the same type of appliance as network device 100 but more generally could be any type of network appliance such as a storage appliance, an anti-spam appliance, or a virtual machine appliance. Network-attached storage device 134 may include one or more hard disk drives or RAID arrays and may, for example, operate as a file server. Server 136 may be any type of hardware device running a computer program to serve the requests of other programs or clients that may run on platforms connected to network 130 or on platforms connected to an external network 140. Computer 138 represents a generic computing device that is connected to network 130. (The term computer is used here in a broad sense to include: computing devices such as servers, computer appliances, desktop computers, laptop computers, tablets, game consoles, electronic books, smart phones, other devices having processors; virtualized computing or storage elements; or other structures capable of implementing the processes described herein, and combinations of such physical or virtualized computing and storage devices, elements, and structures that collectively perform the processes described herein.)

Network device 100 in FIG. 1B includes processor 102, memory 104 containing primary connection table 110, storage 106 that may contain secondary table 120, and program memory 108 containing instructions or code for processes that processor 102 can execute. Memory 104 may be RAM or other fast memory that is within the address space of processor 102. Primary connection table 110 can thus maintain entries 112 in memory 104 that processor 102 can rapidly access, so that processor 102 executing instructions from program memory 108 can use entries 112 to act on data flow with minimal latency. However, the size of memory 104 may limit the size of primary connection table 110. Accordingly, primary connection table 110 (if used alone) has a limit on the number of entries 112 that primary connection table 110 can contain. Current high-end firewall appliances may, for example, have a connection table with a maximum of 2 to 5 million entries.

Storage 106, which stores secondary connection table 120, can be any type of data storage that is accessible to network device 100 and does not need to be in the address space of processor 102. In one implementation, storage 106 is a hard disk drive or RAID that is connected to or part of network device 100. Secondary table 120 can alternatively or additionally be stored in any accessible storage in any device on the network 130 that network device 100 may protect. FIG. 18 illustrates examples in which secondary table 120 may be stored in appliance 132, network-attached storage 134, server 136, or any computer 138 on network 130 and having available storage. Alternatively, secondary table 120 could be stored on a device or devices 142 connected to external or public network 140.

Storage for secondary connection table 120 is not limited to being fast access memory, e.g., in the address space of processor 102. Accordingly, secondary connection table 120 can be much larger than memory 104, and available entries 122 in secondary connection table 120 can greatly outnumber the entries 122 in primary table 112. Also, since network device 100 is not limited to internal storage for secondary table 120, network device 100 can easily add available external storage, so that secondary table 120 and the maximum number of connections that network device 100 can handle can easily scale to any required capacity without the need to after or replace network device 100 or add additional appliances to network 130. In one implementation, secondary connection table 120 is stored in user space virtual memory of processor 102, backed by a large page file on a hard disk, so secondary connection table 120 may be able to grow to huge numbers of entries 122. Accordingly, connection table entries with state information can be loaded into or offloaded from the primary connection table 110 based on needs. Secondary connection table entries 122 can keep together all the necessary state information that some prior systems using a single connection table would release and lose when freeing space in a connection table.

Program memory 108 contains software that processor 102 can execute to perform processes such as described further herein. Program memory 108 may be physically part of the same memory that stores primary connection table 110, and even a logical separation of program memory 108 from memory 104 may be unnecessary. Alternatively, program memory 108 may be logically or physically separate from memory 104 and may include a different type of memory, e.g., ROM. Some examples of the functions of the modules stored in program memory 108 may be to implement a firewall, an intrusion prevention system, or other network security applications, that may filter communications between network 130 and network 140. In a firewall type of application, each connection or session between network 130 and network 140 is typically represented by an entry 112 or 122 in primary or secondary connection table 110 or 120.

Program memory 108 of FIG. 1B is the specific example that includes reaping module 150, a control module 152, a lookup module 154, an offload module 156, and a reload module 158. Control module 152 may contain routines executed to perform the data flow functions of device 100. In particular, control module 152 may perform the functions of a network security device. For example, for a firewall or intrusion prevention system, control module 152 may evaluate data packets or more generally communication to be transmitted between networks 130 and 140 and pass, drop, or reject the data packets or communication according to rules that a user may provide. Control module 152 may particularly employ lookup module 154 to determine whether a data packet corresponds to an existing entry in primary connection table 110 or secondary connection table 120. Control module 152 may further provide an interface for user input of rules or parameters that control module 152, lookup module 154, offload module 156, reload module 158, and reaping module 150 used when performing their respective functions.

Offload module 156 can offload aging entries 112, including the state information for such connections or sessions, from primary connection table 110 to secondary connection table 120. This offload can go to secondary connection table 120 in any available storage including but not limited to local storage 106, an appliance 132 (which may be a policy server), or a software component such as implemented in a cloud service. Reload module 158 performs the reverse process of moving an entry 122 with state information from secondary connection table 120 into primary connection table 110. Reaping module 150 may be responsible for deciding which entries 112 in primary connection table 110 to offload to secondary connection table 120 and may activate offload module 154 to offload the selected entries 112 to secondary connection table 120, creating space in primary connection table 110. Reaping module 150 may particularly be performed as a repeated or periodic maintenance process that ensures that space for new entries is always available in primary table 110. Alternatively, reaping module 150 may operate at need, for example, when control module 152 determines that primary table 110 does not have available space for a required action.

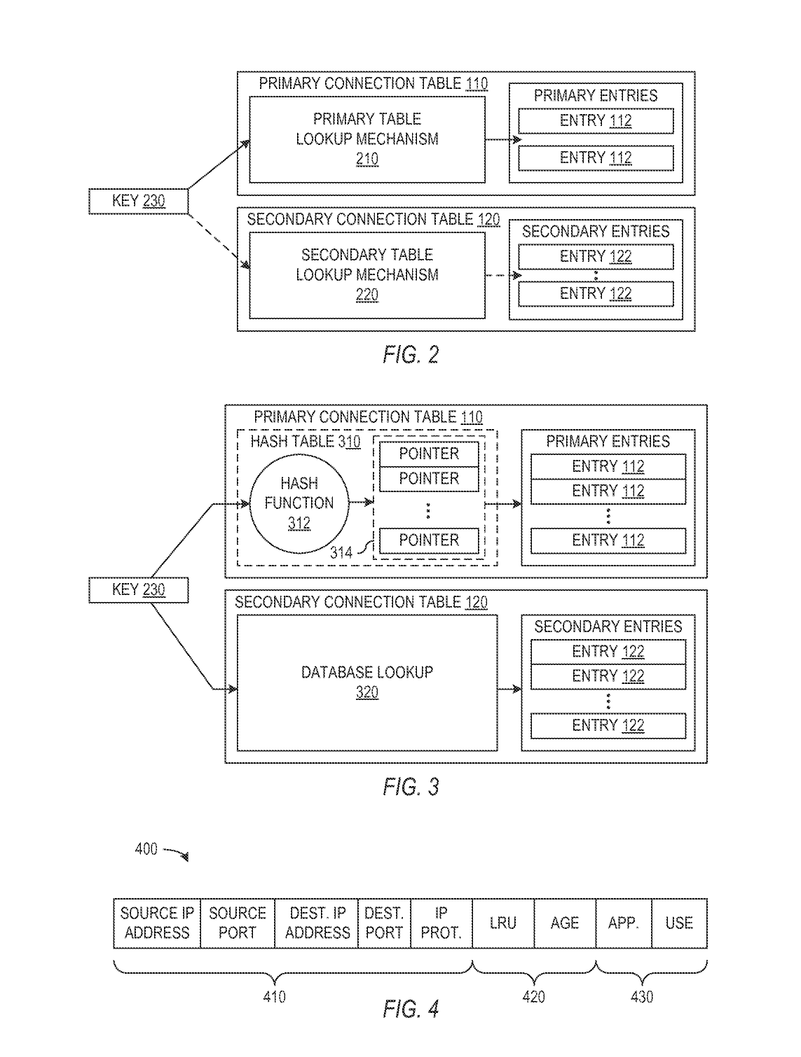

Network device 100 may need to track every active connection going through device 100 and may employ tracking techniques that balance lookup and deletion speed with storage efficiency. FIG. 2 illustrates logical relationships between primary connection table 110 and secondary connection table 120 in an implementation using separated lookup structures. In particular, primary connection table 110 contains entries 112 respectively corresponding to active connections and a lookup mechanism 210. Lookup mechanism 210 generally includes a data structure that enables identification of an entry 112 that corresponds to a key 230 identifying the connection. For example, a value of key 230 for a connection may be assigned based on a 5-tuple, e.g., source IP address, destination IP address, source port, destination port, and protocol, for that connection. Several types of lookup mechanisms are known for connection tables and could be used for lookup mechanism 210. For example, primary connection table 110 could employ a lookup mechanism 210 using a data structure such as a hash table, linked lists, balanced binary trees or other tree structures, compressed binary files, or a relational database.

Secondary connection table 120 in the implementation of FIG. 2 similarly includes secondary entries 122 and a lookup mechanism 220 that facilitates rapid identification of an entry 122 corresponding to a value of key 230 identifying a connection. Lookup mechanism 220 may be of any desired type including data structures such as a hash table, linked lists, balanced binary trees or other tree structures, compressed binary files, or relational databases. Lookup mechanism 220 may particularly be of the same type as lookup mechanism 210, but since secondary connection table 120 may be much larger than primary lookup table 110, lookup mechanisms 210 and 220 may be of different types. The types of lookup structures 210 and 220 may, for example, be selected to optimize a lookup process for tables of the respective sizes of connection tables 110 and 120. Also or alternatively, lookup structure 220 may be of a different or slower type than is lookup structure 210 since latency for the lookup process of secondary table 120 may be less critical For example, a digest of the contents of secondary table 120 may be employed for lookup mechanism 220. Whatever the type of lookup structure 220, secondary connection table 120, including lookup structure 220, may be stored in any available memory as described above with reference to FIG. 1B. Although all or a portion of lookup structure 220 may be in main memory 104 for faster lookup operations, such a configuration may reduce the available storage for primary connection table 110 and may be unnecessary. In particular, lookup operations of secondary connection table 120 may be expected to be slower than lookup operations for primary connection table 110 because secondary connection table 120 may be much larger than primary connection table 110, but slower lookup operations may be acceptable for secondary connection table 120 because use of secondary connection table 120 may be rare compared to use of primary connection table 110.

FIG. 3 shows one particular implementation of primary and secondary connection tables 110 and 120. In particular, primary connection table 110 uses a hash table 310 for lookup of entries 112, and secondary connection table uses another database lookup mechanism 320 for lookup of entries 122. In a lookup process using hash table 310, key 230 may be input to a hash function 312 that generates an index or address of a corresponding one of the hash buckets 314 associated with primary connection table 110. Hash buckets 314 and primary connection table 110 may be kept in fast memory, e.g., memory 104, which is in address space of processor 102 in network device 100 of FIG. 1B. In the implementation of FIG. 3, each hash bucket 314 contains a pointer to an entry 112 in primary connection table 110, but each hash bucket 314 could alternatively contain an entry 112 with status information. To address possible hash collisions, pointers in buckets 314 may alternatively point to (or buckets 314 may contain) a linked list of entries 112, and the value of key 230 can be used to distinguish connections in the linked list if hash function 312 produces the same index or address for two or more distinct connections.

The same key 230 can be used in the lookup structure of secondary table 120. Since secondary connection table 120 may be much larger than primary connection table 110, secondary connection table 120 may employ a different type of lookup structure from the type of lookup structure employed in primary connection table 110. In the implementation of FIG. 3, secondary connection table 120 uses a database lookup mechanism 320 such as a database index. Database indices can be created using one or more columns of a database table, which in this case may be secondary entries 122. Many other types of lookup mechanisms for databases and connection tables are known and could be employed.

Primary connection table 110 and secondary connection table 120 use connection table entries 112 and 122 that describe an associated connection including state information. FIG. 4 shows one example of a format for a connection table entry (CTE) 400, which could be used for entries 112 or entries 122. In general, entries 112 and 122 may have the same or different formats, but each entry 122 should minimally include the data that reload module 158 needs to reconstruct an entry 112 during a reload operation. CTE 400 includes three parts: connection lookup data 410, e.g., a 5-tuple, that identifies a connection; connection use data 420, e.g., information such as the time of last use or age of the connection; and application-specific data 430 that may identify the application associated with a connection and indicate the purposes or use of the connection. Connection lookup data 410, connection use data 420, and application-specific data 430 can be initialized when an entry for a connection is created, offloaded, or reestablished. For example, the identity of the application using a connection may be determined through deep packet inspection, proxying or other techniques and identifying information can be stored in an entry 112 as application-specific data 430. Data in an entry 400, particularly connection use data 420, may also be updated if necessary each time a data packet for the connection is processed. A reaping process can use connection lookup data 410, connection use data 420, or application-specific data 430 for a connection in determining when the connection can be moved from the primary connection table to the secondary connection table.

The format of entry 400 shown in FIG. 4 is only an example. More generally the content of an entry 112 or 122 may depend on the nature of the connection and the type of reaping process to be employed. For example, an entry 112 or 122 may include application-specific data 430 to track the application in use on the connection, number of bytes sent or received on the connection, or a connection state, e.g., for a connection using a TCP protocol. Alternately, a control or reaping process may be able to infer an application identity from the port information, which is in the connection lookup data 410, so that application-specific data 430 may contain less information or be unnecessary. Use of port information to identify an application may be less accurate but may reduce the storage necessary for a connection table.

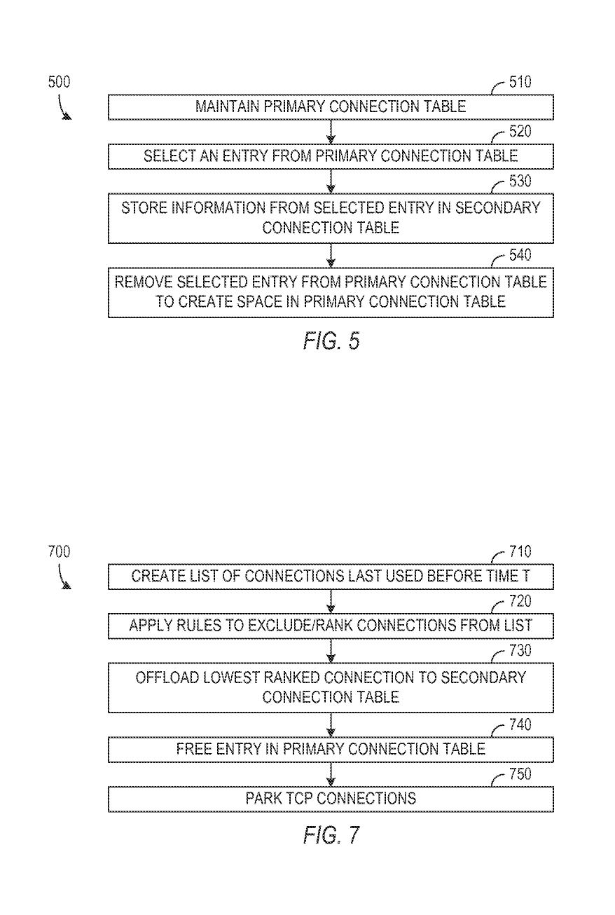

FIG. 5 shows a general process 500 in which a device 100 can use primary connection tables. The following description of processes refers to the structure of network device 100 of FIG. 1B to provide a concrete example. However, such processes could employ different mechanisms and devices. In process 500, a block 510 represents a process of maintaining primary connection table 110 in a manner according to the functions of device 100. For example, for a firewall application, device 100 may create new connections and entries 112 in primary connection table 110 when a requested connection meets the requirements or parameters established for protection of network 130, may look up and use the appropriate entry 112 when handling a received data packet, and may delete an entry 112 when a corresponding connection is no longer needed. However, to maintain space in primary connection table 110, device 100 in block 520 may select one or more entries from primary connection table 530 for offloading from primary connection table 520. This selection may be made based on user criterion or business logic such as described further herein. Once an entry is selected for offloading, a block 530 stores information from the selected entry 112 into an entry 122 that may be newly created in secondary connection table 120. A block 540 can then remove the selected entry 112 from primary connection table 540 to create free space in primary connection table 110. Process 500 can be executed in a repeated or ongoing manner to maintain space in primary table 110 or can be executed at need to create space for a new or reloaded entry 112 in primary connection table 110.

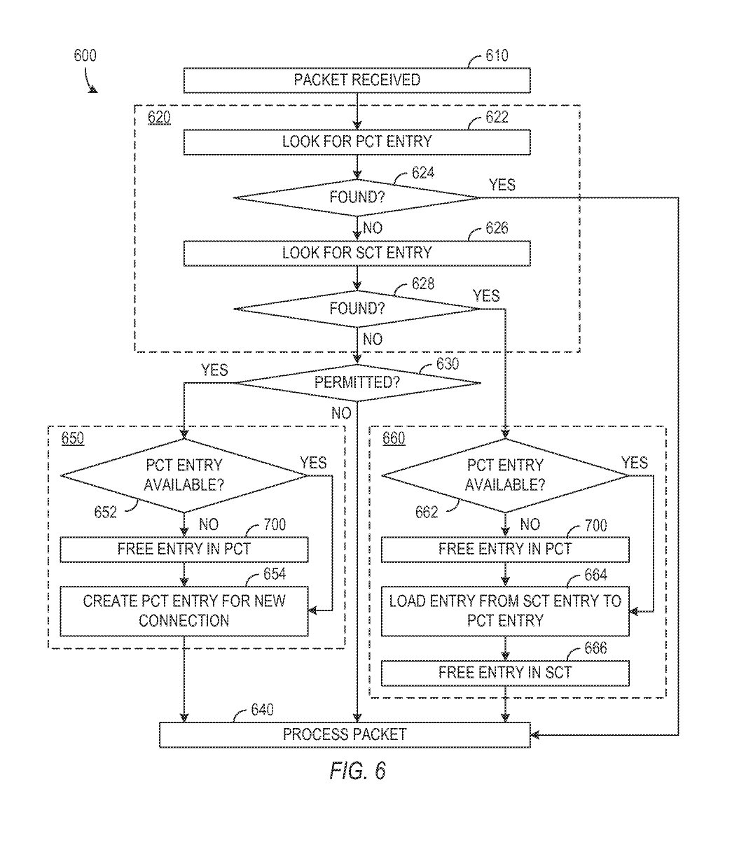

The use of primary and secondary connection tables may also alter the manner in which entries for connections are found and used. FIG. 6, for example, is a flow diagram of a process 600 for handling a data packet by a network device that uses primary and secondary connection tables. Process 600 begins in a block 610 with receiving a communication packet at network device 100. A 5-tuple is generally associated with the packet and identifies a connection to which the packet belongs. Network device 100 in block 620 can then look for an entry 112 in either primary connection table 110 or an entry 122 in secondary connection table 120.

FIG. 6 shows a specific implementation of block 620 that uses separate lookup processes for primary connection table 110 and secondary connection table 120, e.g., as provided by the table implementation of FIG. 2. In particular, block 622 looks for an entry in primary connection table 110, and if decision block 624 determines that a connection table entry 112 corresponding to the connection has been found in primary connection table 110, a block 640 can process the packet in a conventional manner according to the purpose of network device 100. For example, if network device 100 is a firewall, block 640 may pass, drop, or reject the packet according to rules established for connections. If decision block 624 determines that an entry corresponding to the connection was not found in primary connection table 110, block 626 looks for an entry 122 that is in secondary connection table 120 and corresponds to the connection. If a decision block 628 determines that an entry was also not found in secondary connection table 620 and a decision block 630 determines that the connection is permitted, a block 650 may create a new entry 112 in primary connection table 110 for the connection. If block 628 determines that secondary connection table 120 includes an entry 122 corresponding to the connection, a block 660 can retrieve the entry from the secondary connection table 120, for example, by moving the information from an entry 122 to an entry 112 in table 110 as described further below. In either case, when block 650 or 660 provides an entry 112 in primary connection table 110 for the connection corresponding to the packet received, block 640 can process the packet according to the function of the device 100.

Block 650 creates a new entry 112 in primary connection table 110, and one specific implementation of block 650 is illustrated by blocks 652, 700, and 654 in FIG. 6. In the illustrated implementation, an entry-creation process 650 in block 652 first determines whether primary connection table 110 has available space for addition of a new entry. If there is space in primary connection table 110, block 654 can create the new entry 112 for the connection using whatever method is required by the lookup structure and process for primary connection table 110. For example, using the hash table implementation of FIG. 3 (and ignoring hash collisions), a pointer to the new entry 112 can be stored in the hash bucket 214 corresponding to the index or address that hash function 312 generated from the 5-tuple of the connection, and that entry 112 is filled with the information corresponding to the connection. When there is no available space in primary connection table 110, process 650 can execute a reaping process 700 to free space in the primary connection table 110 by moving one or more primary connection table entries 112 to secondary connection table 120, thereby creating one or more secondary connection table entries 122, before block 654 creates the new entry 112 in primary connection table 110 for the new connection.

Block 660 reloads or reestablishes an entry from secondary connection table 120 into primary connection table 110 and similarly requires available space in primary connection table 110 for a reloaded entry 112. In one specific implementation of reload process 660 shown in FIG. 6, a block 662 determines whether primary connection table 110 has available space for loading of an entry from secondary connection table 120. If there is space in primary connection table 110, block 664 can load information from an entry 122 in secondary connection table 120 into an available entry 112 in primary connection table 110. The secondary connection table entry 122 can then be freed in block 666, which may further include releasing space in the lookup structure of secondary connection table 20. When there is no available space in primary connection table 110, reaping process 700 can be executed to free space in the primary connection table 110 before block 664 reloads the entry as described for blocks 664 and 666.

Block 700 corresponds to a reaping process that makes space in primary connection table 110 by removing one or more entries 112 from primary connection table 110. However, reaping of entries 112 may include offloading the information from entries 112 in primary connection table 110 to corresponding entries 122 in secondary connection table 120. Reaping process 700 may be performed whenever space is needed, e.g., when table 110 is full and an entry 112 needs to be created as in process 650 or 660, or reaping process 700 can be performed periodically or whenever the available space in primary connection table 110 approaches a trigger level, e.g., when primary connection table 110 is 80% or 90% full. One implementation of network device 100 of FIG. 18 allows a user to define a rule that determines when reaping process 700 is performed. For example, as part of the connection management, information may be added to an entry for a connection as data packets for the connection are permitted until a trigger piece of information is seen that affects the suitability of moving the connection to move to the secondary connection table.

FIG. 7 is a flow diagram illustrating one implementation of reaping process 700. In general, reaping process 700 can prioritize entries 112 in primary connection table 110 according to any desired business logic and can reap entries corresponding to connections that the business logic indicates have the lowest priority for staying in primary connection table 110. One specific implementation, which is shown in block 710, employs a least recently used (LRU) rule to identify connections that have been inactive for a long time. In particular, block 710 creates a list of connections that were last used before some time T. A block 720 can then alter or order the list according to rules that may exclude some entries from being offloaded or prioritize the old entries 112 according to which connections have the greatest need to be kept in primary connection table 110. In particular, some types of connections may have a low tolerance for latency and would therefore have a higher priority for being kept in primary connection table 110. Connections associated with applications that are particularly sensitive to latency may be excluded from the list and therefore kept in primary connection table 110. Connections associated with applications that are tolerant of latency or that commonly having long breaks between active traffic, e.g., web printer connections, may he preferred for offloading to secondary connection table 120.

Block 730 can then offload one or more entries 112 having the low priority for being kept in primary connection table 110. Each offloaded entry 112 fills an entry 122 in secondary connection table 120 with information based on the information associated with offloaded entry 112. Block 740 can make the memory space once occupied by the offloaded entry 112 available for use by a new entry 112. Offloading may similarly free space in the lookup mechanism of primary connection table 110.

Systems and processes described herein may have the advantage of eliminating the connection/session ceiling of a network device. There may be no practical limit to the number of connections supported on a given appliance. The only limit will be the size or capacity of storage devices. A further benefit that may be achieved in network devices is the hardening of such networking devices to denial of service attacks that attempt to exhaust the connection table.

Some systems and processes described herein can be implemented using a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A process comprising:
maintaining a primary connection table in a memory of a network device;
selecting from among entries in the primary connection table an entry to be removed from the primary connection table in order to create space for an entry in the primary connection table;
removing the selected entry from the primary connection table; and
storing information from the selected entry in an entry of a secondary connection table.

2. The process of claim 1, further comprising in response to a communication of a connection corresponding to the selected entry that was removed from the primary connection table, using the information from the entry of the secondary connection table to reestablish in the primary connection table an entry that corresponds to the connection.

3. The process of claim 1, wherein the memory is in an address space of a processor of the network device.

4. The process of claim 1, wherein the secondary connection table is in a storage system is that is external to the network device.

5. The process of claim 1, wherein the primary connection table comprises a first lookup structure of a first type, and the secondary connection table comprises a second lookup structure that is of a second type that is different from the first type.

6. The process of claim 1, wherein selection of the entry is based on when a connection corresponding to the selected entry was last used and based on a type of the connection.

7. The process of claim 6, wherein the type indicates a tolerance that the connection corresponding to the entry has for latency.

8. The process of claim 1, further comprising:
receiving a data packet at the network device;
looking in the primary connection table and the secondary connection table for an entry corresponding to the data packet; and in response to finding an entry in the secondary connection table;
using the entry found in the secondary connection table to create an entry that is in the primary connection table and corresponds to the data packet; and
processing the data packet using the entry created in the primary connection table.

9. The process of claim 1, further comprising scaling a size of the secondary connection table as required to accommodate entries removed from the primary connection table.

10. The process of claim 1, further comprising increasing the size of the secondary connection table by employing available storage on a network that is connected to the network device.

11. A network device comprising:
a processor;
a memory in an address space of the processor, wherein the memory stores a primary connection table; and
a reaping module executed in the network device, wherein the reaping module operates to select an entry from among entries in the primary connection table and to offload information from the selected entry to a secondary connection table.

12. The device of claim 11, wherein the reaping module employs storage available on a network connected to the device to scale a size of the secondary connection table as necessary to accommodate information offloaded from the primary connection table.

13. The device of claim 11, further comprising a lookup module configured to identify from among the entries in the first and secondary connection an entry corresponding to a data packet received at the device.

14. The device of claim 11, further comprising a storage system that is separate from the memory and contains the secondary connection table.

15. The device of claim 14, wherein the storage system includes a hard drive.
